(19) United States
(12) Patent Application Publication
(10) Pub. No.: US 2014/0351116 A1
(43) Pub. Date: Nov. 27, 2014

(54) Systems for Using Crowdfunding Funds for a Risk Pairing

(71) Applicant: Jennie Hoff, Littleton, CO (US)

(72) Inventor: Jennie Hoff, Littleton, CO (US)

(21) Appl. No.: 14/333,443

(22) Filed: Jul. 16, 2014

Related U.S. Application Data
(60) Provisional application No. 61/847,460, filed on Jul. 17, 2013.

(51) Int. Cl. G06Q 40/02

(52) U.S. Cl. CPC G06Q 40/025; G06Q 40/06
USPC 705/38

(57) ABSTRACT

Systems and methods for funding a risk pairing of a fundable business and a beneficiary for presentation to investors and crowdfunding backers. The suppliers of funds channel the funds through a crowdfunding portal, or broker, to provide debt to the fundable business. During designated times, all or a portion of the repayments may be returned to the investor by the beneficiary through the crowdfunding portal. This allows the investor to supply funds to the business without the investor directly lending to the business. It also allows the business to borrow funds without a subsequent repayment by the business.

### CROSS-REFERENCE TO RELATED APPLICATIONS

A claim of priority is made in this application based on Provisional Application Ser. No. 61/847,460 filed on Jul. 17, 2013, and entitled “Systems, Methods, Apparatuses and Products Related to Using Investment Funds for Charitable Donations” the disclosure of which is hereby incorporated by reference in its entirety.

### BACKGROUND

1. Field

Disclosed are systems and methods related to the crowdfunding of a risk pairing including the funding of a fundable business using investment funds.

2. Background of the Invention

While crowdfunding is often associated with equity investments, it is anticipated new laws will allow a market for unaccredited crowdfunding backers to fund private businesses with debt instruments. Models exist in some countries, but in the form of peer-to-peer lending. Through this model, entities directly approach investors for a loan with a return for interest. This provides a new avenue for acquisition of note-based loans. However, this form of lending is fraught with high risk and high cost for investors. Individual investors do not have the resources and skill to properly perform due diligence on a company. Compliance can cost tens of thousands of dollars, and quiet periods can make the lending period last months. The result is that these types of investments are too difficult for a single investor to underwrite.

For borrowers, courting investors is a cumbersome and time-consuming task that doesn't parallel their short-term funding needs. Interest rates can vary widely and are generally out of the control of the borrower to negotiate. High government fees may also be passed to borrowers, which push total interest rates to intolerable limits.

All of the funding systems heretofore known suffer from a number of disadvantages:
Limits the types of fundable businesses for a crowdfunding backer;
Limits the size of the fundable business for a crowdfunding backer;
Limits the types of crowdfunding investments based on federally mandated fee requirements;
Limits the types of crowdfunding investment based on federally mandated suspense periods;
Limits the ability of the crowdfunding backers to assess a risk pairing of the fundable business and the incidental beneficiary.

### SUMMARY

Embodiments of the disclosed systems and methods may be useful and novel as a result of their enabling the provision of funds to a fundable business where a portion of the fundable business's revenue is contributed by an incidental beneficiary to repay funds.

Various embodiments may alternately or also:
Enable crowdfunding business investments for debt and equity splits;
Establish fair market value for a risk pairing;
Provide an investor control of the funds contributed by the broker;
Allow a fundable business to avoid debt repayment; or
Allow beneficiary extended terms on contractual payment.

Systems and methods that may meet some or all of the needs stated above and may enable investor funds to be directed to a fundable business for the benefit of an incidental beneficiary. In one embodiment the investor may supply funds to an investor-influenced account with directions on funding the fundable business as a part of a risk pairing. In another embodiment, crowdfunding backers may supply funds generated in a crowdfunding portal to an investor-influenced account for providing debt to the fundable business whereby the business does not pay back the debt. In a different set of embodiments, both investors and backers may contribute funds through a crowdfunding site to investor-influenced account where the beneficiary provides a return to the investors.

Various embodiments of the disclosed systems and methods may alternately or also:
a) provide new sources of funding for fundable businesses;
b) provide investors new options for return and timing on return;
c) provide investors the ability to supply funds to a risk pair without directly funding the business;
d) provide brokers with sources of fundable businesses;
e) provide crowdfunding as an option for debt obligations;
f) provide secure fund agreements for debt obligations;
g) provide fundable businesses with controlled cash flow;
h) provide fundable businesses with non-bankable capital;
i) provide beneficiaries with extended terms on contracts for goods and services.

Further objects and advantages of at least some of the disclosed embodiments will become apparent from a consideration of the drawings and the ensuing description of the drawings. Although the disclosed embodiments and some of their advantages have been described in detail, it should be understood that various changes, substitutions or alterations may be made without departing from the spirit and scope of the disclosure as defined at least in part by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

In the foregoing description and following claims, method steps and actions are described in a particular order for the purposes of illustration. It should be appreciated that in alternate embodiments, the method steps and actions may be performed in a different order than that described. Additionally, the methods described above and below may be embodied in machine-executable instructions stored on one or more machine-readable mediums, such as disk drives or CD-ROMs. The instructions may be used to cause the machine (e.g., computer processor) programmed with the instructions to perform the method. Alternatively, the methods may be performed by a combination of hardware and software. While illustrative and presently preferred embodiments of the invention have been described in detail herein, it is to be understood that the inventive concepts may be otherwise variously embodied and employed and that the appended claims are intended to be construed to include such variations except as limited by the prior art.

### DRAWING FIGURES

The accompanying drawings, which are incorporated in and constitute a part of this specification, illustrate embodiments of the present invention and together with the description serve to explain the principles of this invention. In the figures:

FIG. 1A-A flow chart illustrating the paths of information and funds when a broker lends to the risk pairing using an investor-influenced account.

FIG. 1B-A flow chart demonstrating the transfer and conversion of equity and debt funds between the systems.

### REFERENCE NUMERALS IN DRAWINGS

10 Investor
14 Investor-influenced distribution
22 Distribution
24 Fund agreement
30 Beneficiary, incidental beneficiary
31 Beneficiary system
40 Fundable business
41 Fundable business system
50 Pairing, risk pairing
52 Risk pairing score
60 Broker, intermediary
70 Crowdfunding portal
80 Crowdfunding backer
81 Crowdfunding backer system
90 Debt
92 Debt funds transfer
96 Debt notification
104 Equity return transfer
106 Suspense equity account
110 Revenue

### DETAILED DESCRIPTION OF THE DRAWINGS

Referring to the drawings, in which like numerals represent like elements,

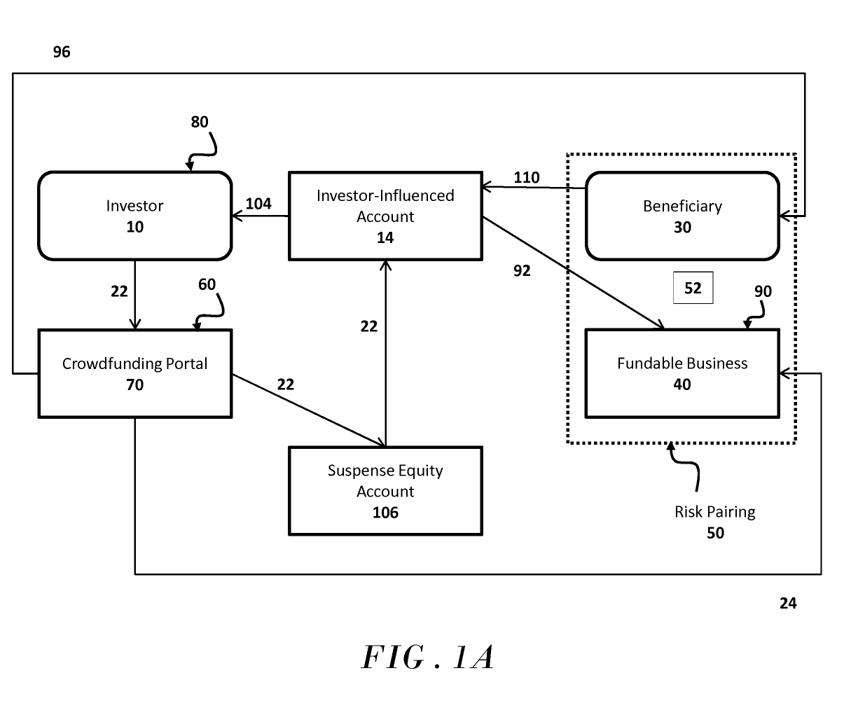

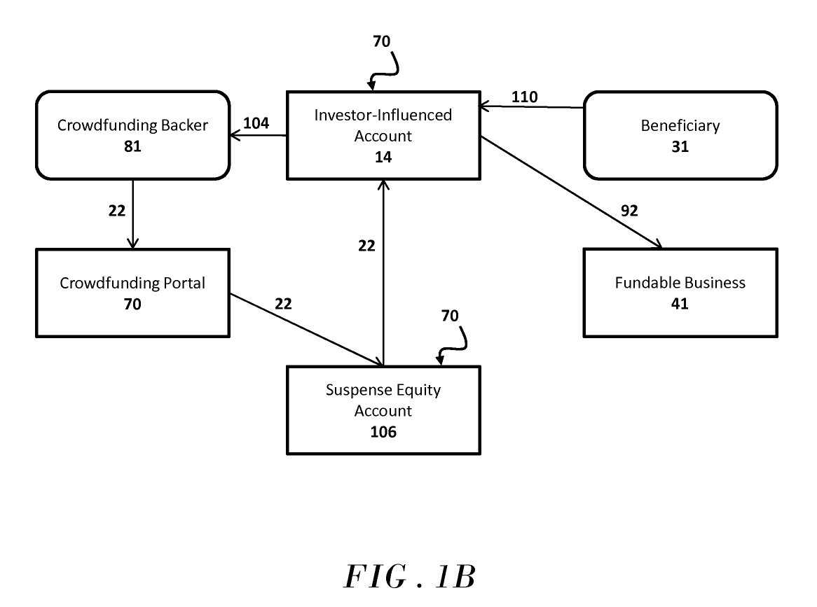

FIG. 1A-1B

Turning to FIG. 1A, a flow chart illustrating the flow of information and funds when a broker 60 lends to the risk pairing 50 using an investor-influenced account 14.

An investor 10, or crowdfunding backer 80, creates an account at the crowdfunding portal 70 and logs into the system 70. The crowdfunding portal 70 contains databases that store and organize information for the investor 10 about the fundable business 40 and beneficiary 30. Additional crowdfunding portal systems and databases comprise risk-pairing analysis, financial tracking, account management, investment tracking tools, investors' funds subaccount, audit, reporting, notification, exception analysis, note generation, fee management, and institutional-funds transfer systems.

A fundable business 40 is an entity or person the broker 60 has processed and presented on the crowdfunding portal 70. Processing comprises collecting financial, application, credit, security, and note data. The broker 60 may then assign a risk profile and summarize key data for potential backers 80.

A beneficiary 30, or incidental beneficiary 30, is an entity or individual that may not be contracted with the broker, 60 or crowdfunding portal 70, and may be unaware there is a relationship between the fundable business 40 and crowdfunding portal 70. Even without this knowledge, the beneficiary 30 receives economic advantages such as extended terms on goods and services received from the fundable business 40.

The beneficiary 30 may also be a direct beneficiary and contract with the broker 60 for extended terms from the fundable business 40. The broker 60 would then pay a portion of the funds due to the fundable business. This allows the beneficiary 30 extended terms on contracts for goods and services that the fundable business 40 does provide.

A broker 60 comprises accredited broker, non-accredited brokers, crowdfunding brokers, financial managers, for-profit, and non-profits such as donor-advised funds. The broker 60 has no claim on the investors' 10 funds except for fees derived from the transactions.

Investors 10 are able to use the data in the crowdfunding portal 70 to determine an appropriate level of risk that aligns with their personal risk-to-reward preferences. Investors 10 analyze the fundable risk pair 50 to make an informed investment decision. Since investors perform their own risk-to-reward analysis, an investment could have hundreds of separate analyses. This democratizes the risk-to-reward decision for the risk pairing 50. Investors 10 may decide to provide funds to fundable businesses 40 that are not fully funded or buy a portion of note of a fundable business 40 that is fully funded by the crowdfunding portal 70.

A risk pairing 50 is the combination of a beneficiary 30 and fundable business 40. The pairing 50 is analyzed as a couple by both the intermediary 60 and investors 10. This allows the lower-risk entity of the pair 50 to provide a credit halo to the other entity. The result is a risk pairing score 52 determined by the broker 60 and used by the investor 10 to evaluate an investment. Once paired, the crowdfunding portal 70 may provide a funding agreement 24 to the fundable business 40. The funding agreement 24 comprises the terms of the agreement and a note. The funding agreement 24 may be provided to the fundable business 40 at any time until the debt funds transfer 92. The beneficiary 30 is not a party to the note or fund agreement 24.

During the account setup, the investor 10 transfers a distribution 22 of funds to the crowdfunding portal 70. The crowdfunding portal 70 places the distribution 22 in a suspense equity account 106. The suspense equity account 106 holds funds that have yet to be determined, by the investor 10, what risk pairing 50 will be provided an investment. Once an investor 10 selects a risk pair 50, the distribution 22 is transferred to the investor-influenced account 14. In a preferred embodiment, the investor distribution 22 is not transferred to the investor-influenced account 14 until risk pairing 50 is fully funded.

When either a partial or fully funded milestone is reached, the broker 60 converts the equity in the investor-influenced account 14 to debt and electronically executes a debt funds transfer 92 from the investor-influenced account 14 to the fundable business 40. The milestone may comprise a single transaction, a timetable, or a total funding amount.

The fundable business 40 does not treat the debt funds transfer 92 as debt 90 because the business 40 is not responsible for repayment of the debt 90. The business 40 books the debt funds transfer 92 as revenue 110. The debt funds transfer 92 triggers a debt notification 96 to the beneficiary 30. This may be the first time the beneficiary 30 becomes aware they are part of a risk pairing 50. The beneficiary 30 is notified that a portion of the fundable business's 40 revenue that was to be supplied by the beneficiary 30 is now owned by the broker 60. The beneficiary 30 is advised they will alternately transfer to the broker 60 a specific amount of the beneficiary's 30 accounts payable for the fundable business 40.

On the date established in the terms of the original contract between the fundable business 40 and beneficiary 30, the beneficiary will transfer the fundable business's revenue 110 to the intermediary 60. This may be transferred to the suspense equity account 106, the investor-influenced account 14, or another account determined by the broker 60.

Finally turning now to FIG. 1B, a flow chart demonstrating the transfer, and conversion, of equity and debt funds between the disparate systems.

The crowdfunding backer 80 may initiate the process by accessing his account at the crowdfunding portal 70 and transferring a distribution from the backer's system 81 to the crowdfunding portal 70. The backer's system 81 comprises institutions capable of an electronic transfer for funds and the systems to direct and execute that transfer.

The crowdfunding portal 70 moves the distribution 22 into a suspense equity account 106. Once directed by the backer's 80 selection of a risk pair 50, the crowdfunding portal 70 transfers the distribution 22, in the amount specified by the backer 80, to the investor-influenced account 14. At a pre-established milestone, the broker converts the equity in the investor-influenced account 14 to debt 90 and executes a debt funds transfer to the fundable business's system 41. The milestone may comprise a single transaction, a timetable, and a total funding amount. Additional crowdfunding portal systems and databases comprise risk pairing analysis, financial tracking, account management, investment tracking tools, investors' funds subaccount, audit, reporting, notification, exception analysis, note generation, fee management, intra-institutional funds transfer systems and inter-institutional funds transfer systems.

The fundable business system 41 comprises hardware, databases, systems, and institutions capable of an electronic transfer for funds and the systems to direct and execute the debt funds transfer 92.

The beneficiary system 31 is responsible for transferring the revenue 110 to the crowdfunding portal 70. The beneficiary system comprises databases, systems and hardware, and financial institutions capable of monitoring accounts payable, calendar, and funds transfers.

### FURTHER DESCRIPTION

From the description above, a number of advantages of certain embodiments become evident. Such advantages include new benefits for participating parties including investor, beneficiary, fundable business, sponsoring organization, backer, and crowdfunding portal:
a) allows the investor to chose the fundable business and beneficiary pairing;
b) allows the pre-existing risk pairing to be presented to a crowdfunding backer;
c) allows the broker to establish fair market value;
d) allows crowdfunding backers to receive a quick return;
e) allows the pre-existing pairing to be presented to the portal;
f) allows the incidental beneficiary to extend payment terms;
g) allows the fundable business to borrow without a debt repayment;
h) allows the fundable business to assume the credit rating of the incidental beneficiary;
i) allows the fundable business, beneficiary, and investor to have a balance of power.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

In the foregoing description and following claims, method steps and/or actions are described in a particular order for the purposes of illustration. It should be appreciated that in alternate embodiments, the method steps and/or actions may be performed in a different order than that described. Additionally, the methods described above may be embodied in machine-executable instructions stored on one or more machine-readable mediums, such as disk drives or CD-ROMs. The instructions may be used to cause the machine (e.g., computer processor) programmed with the instructions to perform the method. Alternatively, the methods may be performed by a combination of hardware and software. While illustrative and presently preferred embodiments of the invention have been described in detail herein, it is to be understood that the inventive concepts may be otherwise variously embodied and employed and that the appended claims are intended to be construed to include such variations except as limited by the prior art.

Benefits, other advantages, and solutions to problems have been described herein with regard to specific embodiments. However, the advantages, associated benefits, specific solutions to problems, and any element(s) that may cause any benefit, advantage, or solution to occur or become more pronounced are not to be construed as critical, required, or essential features or elements of any or all the claims of the invention. As used herein, the terms “comprises”, “comprising”, or any other variation thereof, are intended to cover a non-exclusive inclusion, such that a process, method, article, or apparatus composed of a list of elements that may include other elements not expressly listed or inherent to such process, method, article, or apparatus.

What is claimed is:

1. A method for electronically funding a risk pairing through an investor-influenced account in a computer network environment, the method comprising:
a. generating the risk pairing of a beneficiary and a fundable business;
b. storing the pairing of the beneficiary and the fundable business in one or more databases;
c. determining a risk pairing score;
d. storing the risk pairing score in one or more databases;
e. presenting the risk pairing to a crowdfunding backer on a crowdfunding portal accessible over a communication network;
f. electronically transferring a crowdfunding backer distribution to the crowdfunding portal;
g. storing the crowdfunding backer distribution in a suspense equity account at the crowdfunding portal;
h. at the crowdfunding backer's request, transferring the distribution to the investor-influenced account;
i. according to the funding agreement, the crowdfunding portal electronically transmitting a debt funds to the fundable business;
j. the beneficiary electronically transmitting a debt repayment to the crowdfunding portal;
k. the crowdfunding portal electronically transmitting at least a portion of the debt repayment to the crowdfunding backer;
whereby, the fundable business borrows from the crowdfunding portal without the need for repayment.

2. A method for electronically funding a risk pairing through an investor-influenced account in a computer network environment, the method comprising:
a. generating the risk pairing of a beneficiary and a fundable business;
b. storing the pairing of the beneficiary and the fundable business in one or more databases;
c. determining a risk pairing score;
d. storing the risk pairing score in one or more databases;
e. presenting the risk pairing to an investor on a crowdfunding portal accessible over a communication network;
f. electronically transferring an investor distribution to the crowdfunding portal;
g. storing the investor distribution in a suspense equity account at the crowdfunding portal;
h. at the investor's request, transferring the distribution to the investor-influenced account;
i. according to the funding agreement, the crowdfunding portal electronically transmitting a debt funds to the fundable business;
j. the beneficiary electronically transmitting a debt repayment to the crowdfunding portal;
k. the crowdfunding portal electronically transmitting at least a portion of the debt repayment to the investor;
whereby, the fundable business borrows from the crowdfunding portal without the need for repayment.

3. A method for electronically funding a risk pairing through an investor-influenced account in a computer network environment, the method comprising:
a. generating the risk pairing of a beneficiary and a fundable business;
b. storing the pairing of the beneficiary and the fundable business in one or more databases;
c. determining a risk pairing score;
d. storing the risk pairing score in one or more databases;
e. presenting the risk pairing to an investor on a crowdfunding portal accessible over a communication network;
f. electronically transferring an investor distribution to the crowdfunding portal;
g. storing the investor distribution in a suspense equity account at the crowdfunding portal;
h. at the investor's request, transferring the distribution to the investor-influenced account;
i. the beneficiary electronically transmitting a debt repayment to the crowdfunding portal;
j. the crowdfunding portal electronically transmitting at least a portion of the debt repayment to the investor;
whereby, the fundable business borrows from the crowdfunding portal without the need for repayment.
